(19) United States
(12) Patent Application Publication
(10) Pub. No.: US 2022/0368782 A1
(43) Pub. Date: Nov. 17, 2022

(54) BASEBAND CHIP AND METHOD FOR LAYER 2 DOWNLINK DATA PROCESSING

(71) Applicant: Zeku Inc., Palo Alto, CA (US)

(72) Inventors: Tianan Tim MA, San Diego, CA (US); Hong Kui YANG, San Diego, CA (US); Su-Lin LOW, San Diego, CA (US); Hausting HONG, San Diego, CA (US)

(21) Appl. No.: 17/813,858

(22) Filed: Jul. 20, 2022

Related U.S. Application Data
(63) Continuation of application No. PCT/IB2020/061306, filed on Dec. 1, 2020.
(60) Provisional application No. 62/966,910, filed on Jan. 28, 2020.

(51) Int. Cl. H04L 69/324

(52) U.S. Cl. CPC H04L 69/324; H04W 80/02

(57) ABSTRACT

Embodiments of apparatus and method for Layer 2 downlink data processing are disclosed. In an example, a baseband chip includes a plurality of Layer 2 circuits and a microcontroller unit (MCU) operatively coupled to the Layer 2 circuits. The Layer 2 circuits are configured to receive Layer 1 transport blocks and generate Layer 3 data packets from the Layer 1 transport blocks in an in-line manner. The MCU is configured to control, through a plurality sets of commands, at least one of the Layer 2 circuits to generate the Layer 3 data packets from the Layer 1 transport blocks.

### CROSS-REFERENCE TO RELATED APPLICATION(S)

This application is a continuation of International Application No. PCT/IB2020/061306, filed Dec. 1, 2020, which claims priority to U.S. Provisional Patent Application No. 62/966,910, filed Jan. 28, 2020, the entire disclosures of which are incorporated herein by reference.

### FIELD

Embodiments of the present disclosure relate to apparatus and method for wireless communication.

### BACKGROUND

Wireless communication systems are widely deployed to provide various telecommunication services such as telephony, video, data, messaging, and broadcasts. In cellular communication, such as the 4th-generation (4G) Long Term Evolution (LTE) and the 5th-generation (5G) New Radio (NR), the 3rd Generation Partnership Project (3GPP) defines a Radio Layer 2 (referred to here as “Layer 2”) as part of the protocol stack structure corresponding to the user plane (also known as the “data plane”), which includes a Packet Data Convergence Protocol (PDCP) layer, a Radio Link Control (RLC) layer, and a Medium Access Control (MAC), from higher to lower in the stack. Layer 2 in 5G NR further includes a Service Data Adaptation Protocol (SDAP) layer.

### SUMMARY

In one aspect, a baseband chip includes a plurality of Layer 2 circuits and a microcontroller unit (MCU) operatively coupled to the Layer 2 circuits. The Layer 2 circuits are configured to receive Layer 1 transport blocks and generate Layer 3 data packets from the Layer 1 transport blocks in an in-line manner. The MCU is configured to control, through a data, at least one of the Layer 2 circuits to generate the Layer 3 data packets from the Layer 1 transport blocks.

In another aspect, a baseband chip includes a buffer, an MAC circuit, an RLC circuit, and a PDCP circuit. The buffer is configured to store Layer 1 transport blocks. The MAC circuit is configured to process MAC headers of the Layer 1 transport blocks received from the buffer. The RLC circuit is configured to process RLC headers of the Layer 1 transport blocks received from the MAC circuit. A PDCP circuit is configured to process PDCP headers of the Layer 1 transport blocks received from the RLC circuit, process payloads of the Layer 1 transport blocks received from the buffer, and generate Layer 3 data packets based on the processed PDCP headers and payloads of the Layer 1 transport blocks.

In still another aspect, a method for Layer 2 downlink data processing is disclosed. A first set of result statuses based on information related to Layer 1 transport blocks is received by an MCU. A first set of commands is provided by the MCU based on the first set of result statuses to control a MAC circuit to process MAC headers of the Layer 1 transport blocks. A second set of result statuses based on the processing result of the MAC circuit is received by the MCU. A second set of commands is provided by the MCU based on the second set of result statuses to control an RLC circuit to process RLC headers of the Layer 1 transport blocks. A third set of result statuses based on the processing result of the RLC circuit is received by the MCU. A third set of commands is provided by the MCU based on the third set of result statuses to control a PDCP circuit to process PDCP headers and payloads of the Layer 1 transport blocks, and generate Layer 3 data packets based on the processed PDCP headers and payloads of the Layer 1 transport blocks.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates an exemplary wireless network, according to some embodiments of the present disclosure.

FIG. 2 illustrates a block diagram of an apparatus including a baseband chip, a radio frequency (RF) chip, and a host chip, according to some embodiments of the present disclosure.

FIG. 3 illustrates a block diagram of an exemplary user plane protocol stack, according to some embodiments of the present disclosure.

FIG. 4A illustrates a block diagram of a baseband chip implementing Layer 2 downlink data processing using a baseband processor.

FIG. 4B illustrates a data flow of the baseband chip shown in FIG. 4A.

FIGS. 5A and 5B illustrate detailed block diagrams of an exemplary baseband chip implementing Layer 2 downlink data processing using Layer 2 circuits and an MCU in an interactive mode and in an automated mode, respectively, according to some embodiments of the present disclosure.

FIG. 5C illustrates an exemplary data flow of the baseband chip shown in FIGS. 5A and 5B, according to some embodiments of the present disclosure.

FIG. 6 illustrates a flow chart of an exemplary method for Layer 2 downlink data processing, according to some embodiments of the present disclosure.

FIG. 7 illustrates a block diagram of an exemplary node, according to some embodiments of the present disclosure.

Embodiments of the present disclosure will be described with reference to the accompanying drawings.

### DETAILED DESCRIPTION

Although specific configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various aspects of wireless communication systems will now be described with reference to various apparatus and methods. These apparatus and methods will be described in the following detailed description and illustrated in the accompanying drawings by various blocks, modules, units, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system.

The techniques described herein may be used for various wireless communication networks, such as code division multiple access (CDMA) system, time division multiple access (TDMA) system, frequency division multiple access (FDMA) system, orthogonal frequency division multiple access (OFDMA) system, single-carrier frequency division multiple access (SC-FDMA) system, and other networks. The terms “network” and “system” are often used interchangeably. A CDMA network may implement a radio access technology (RAT), such as Universal Terrestrial Radio Access (UTRA), evolved UTRA (E-UTRA), CDMA 2000, etc. A TDMA network may implement a RAT, such as GSM. An OFDMA network may implement a RAT, such as LTE or NR. The techniques described herein may be used for the wireless networks and RATs mentioned above, as well as other wireless networks and RATs.

In known solutions, Layer 2 data processing, for example, processing the transport blocks received from Layer 1 in the downlink user plane, is usually implemented using software modules executed on a generic baseband processor, such as a central processing unit (CPU) or a digital signal processor (DSP). During the processing, data needs to be frequently transferred between the generic baseband processor and external memory (e.g., the system memory), for example, for buffering between each layer. As a result, the known solutions for Layer 2 data processing suffer from high power consumption, large data buffer, and long process delays.

Various embodiments in accordance with the present disclosure provide an improved solution for implementing Layer 2 downlink data processing in an in-line manner using dedicated Layer 2 circuits, such as application-specific integrated circuits (ASICs), thereby achieving high performance, low cost, and low power Layer 2 downlink data processing and transmission. The dedicated Layer 2 circuits can process (e.g., formatting, mapping, error checking, etc.) the data on-the-fly at the real transmission time. That is, the hardware implementation disclosed herein can reduce processing delay, buffer size, and power consumption by processing downlink data in an in-line manner through each layer in the Layer 2 protocol stack, not having to access data in system memory frequently.

To adapt the Layer 1 data rate, the baseband chip having the dedicated Layer 2 circuits disclosed herein can work in either an interactive mode or in an automated mode. In the interactive mode, one or more of the Layer 2 circuits are controlled by an MCU, making the Layer 2 circuits programmable. For example, the data processing flow and operations may be modified by programming using the MCU. The Layer 2 circuits can also report the processing results back to the MCU, such that the MCU can dynamically generate or update the control commands, for example, by changing the priorities of the commands based on the process results from the lower layer in the Layer 2 protocol stack, i.e., the previous stage in downlink processing. In this way, the Layer 2 circuits can be very flexible to adapt to any changes in the protocol data flow requirements. In some embodiments, multiple MCUs are used in the interactive mode to improve data rate performance by dedicating each MCU to a respective Layer 2 circuit.

In case the Layer 1 data rate exceeds the processing capability of the interactive mode, the baseband chip can work in the automated mode in which the control commands of a Layer 2 circuit can be automatically generated by another Layer 2 circuit at the lower layer in the Layer 2 protocol stack, as opposed to the MCU. In some embodiments, the headers of one layer in the Layer 2 protocol stack are processed by the corresponding Layer 2 circuit, and the processed headers are used by the Layer 2 circuit to generate the control commands for controlling the other Layer 2 circuit in the upper layer, thereby eliminating the need for reporting the processing results to the MCU. As a result, automated hardware data processing can be realized for Layer 2 downlink data, which further increases the proceeding speed and reduce the die size and power consumption.

In some embodiments, the payload of each Layer 1 transport block is not pulled and read until it is ready to be processed by the PDCP circuit, and the MAC, RLC, and PDCP headers of the Layer 1 transport block are processed in-place without reading the entire transport block. By offloading the MAC and RLC circuits from processing the payloads of the Layer 1 transport blocks, the power consumption can be further reduced.

Moreover, the Layer 2 circuits are scalable based on the number of data flows, the throughput of each data flow, and the total data flows. The Layer 2 circuits can have a scalable number of data buffers and data paths that can be adapted to high-to-low data rate applications. In the interactive mode, the number of MCUs is scalable as well, by adding or removing MCUs as the system scales. Each MCU can communicate with the Layer 2 circuits through on-chip memory (e.g., for command and status queues), local bus, and interrupts on the baseband chip. Further, the clock frequency of the Layer 2 circuits and MCU is scalable as well. For example, lower clock frequencies may result in less die size, cost, and power consumption.

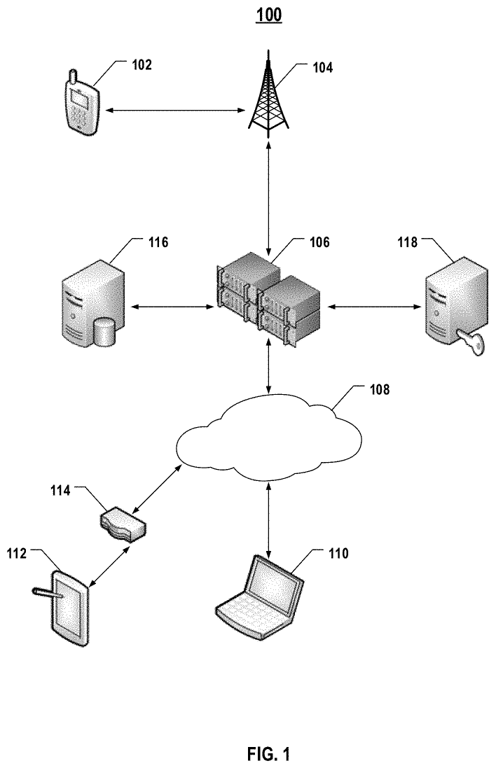

FIG. 1 illustrates an exemplary wireless network 100, in which certain aspects of the present disclosure may be implemented, according to some embodiments of the present disclosure. As shown in FIG. 1, wireless network 100 may include a network of nodes, such as a user equipment (UE) 102, an access node 104, and a core network element 106. User equipment 102 may be any terminal device, such as a mobile phone, a desktop computer, a laptop computer, a tablet, a vehicle computer, a gaming console, a printer, a positioning device, a wearable electronic device, a smart sensor, or any other device capable of receiving, processing, and transmitting information, such as any member of a vehicle to everything (V2X) network, a cluster network, a smart grid node, or an Internet-of-Things (IoT) node. It is understood that user equipment 102 is illustrated as a mobile phone simply by way of illustration and not by way of limitation.

Access node 104 may be a device that communicates with user equipment 102, such as a wireless access point, a base station (BS), a Node B, an enhanced Node B (eNodeB or eNB), a next-generation NodeB (gNodeB or gNB), a cluster master node, or the like. Access node 104 may have a wired connection to user equipment 102, a wireless connection to user equipment 102, or any combination thereof. Access node 104 may be connected to user equipment 102 by multiple connections, and user equipment 102 may be connected to other access nodes in addition to access node 104. Access node 104 may also be connected to other user equipments. It is understood that access node 104 is illustrated by a radio tower by way of illustration and not by way of limitation.

Core network element 106 may serve access node 104 and user equipment 102 to provide core network services. Examples of core network element 106 may include a home subscriber server (HSS), a mobility management entity (MME), a serving gateway (SGW), or a packet data network gateway (PGW). These are examples of core network elements of an evolved packet core (EPC) system, which is a core network for the LTE system. Other core network elements may be used in LTE and in other communication systems. In some embodiments, core network element 106 includes an access and mobility management function (AMF) device, a session management function (SMF) device, or a user plane function (UPF) device, of a core network for the NR system. It is understood that core network element 106 is shown as a set of rack-mounted servers by way of illustration and not by way of limitation.

Core network element 106 may connect with a large network, such as the Internet 108, or another Internet Protocol (IP) network, to communicate packet data over any distance. In this way, data from user equipment 102 may be communicated to other user equipments connected to other access points, including, for example, a computer 110 connected to Internet 108, for example, using a wired connection or a wireless connection, or to a tablet 112 wirelessly connected to Internet 108 via a router 114. Thus, computer 110 and tablet 112 provide additional examples of possible user equipments, and router 114 provides an example of another possible access node.

A generic example of a rack-mounted server is provided as an illustration of core network element 106. However, there may be multiple elements in the core network including database servers, such as a database 116, and security and authentication servers, such as an authentication server 118. Database 116 may, for example, manage data related to user subscription to network services. A home location register (HLR) is an example of a standardized database of subscriber information for a cellular network. Likewise, authentication server 118 may handle authentication of users, sessions, and so on. In the NR system, an authentication server function (AUSF) device may be the specific entity to perform user equipment authentication. In some embodiments, a single server rack may handle multiple such functions, such that the connections between core network element 106, authentication server 118, and database 116, may be local connections within a single rack.

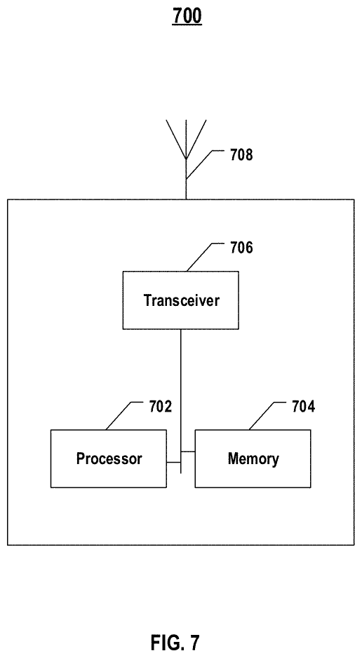

Each element in FIG. 1 may be considered a node of wireless network 100. More detail regarding the possible implementation of a node is provided by way of example in the description of a node 700 in FIG. 7. Node 700 may be configured as user equipment 102, access node 104, or core network element 106 in FIG. 1. Similarly, node 700 may also be configured as computer 110, router 114, tablet 112, database 116, or authentication server 118 in FIG. 1. As shown in FIG. 7, node 700 may include a processor 702, a memory 704, and a transceiver 706. These components are shown as connected to one another by a bus, but other connection types are also permitted. When node 700 is user equipment 102, additional components may also be included, such as a user interface (UI), sensors, and the like. Similarly, node 700 may be implemented as a blade in a server system when node 700 is configured as core network element 106. Other implementations are also possible.

Transceiver 706 may include any suitable device for sending and/or receiving data. Node 700 may include one or more transceivers, although only one transceiver 706 is shown for simplicity of illustration. An antenna 708 is shown as a possible communication mechanism for node 700. Multiple antennas and/or arrays of antennas may be utilized. Additionally, examples of node 700 may communicate using wired techniques rather than (or in addition to) wireless techniques. For example, access node 104 may communicate wirelessly to user equipment 102 and may communicate by a wired connection (for example, by optical or coaxial cable) to core network element 106. Other communication hardware, such as a network interface card (NIC), may be included as well.

As shown in FIG. 7, node 700 may include processor 702. Although only one processor is shown, it is understood that multiple processors can be included. Processor 702 may include microprocessors, MCUs, digital signal processors (DSPs), application-specific integrated circuits (ASICs), field-programmable gate arrays (FPGAs), programmable logic devices (PLDs), state machines, gated logic, discrete hardware circuits, and other suitable hardware configured to perform the various functions described throughout the present disclosure. Processor 702 may be a hardware device having one or more processing cores. Processor 702 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Software can include computer instructions written in an interpreted language, a compiled language, or machine code. Other techniques for instructing hardware are also permitted under the broad category of software.

As shown in FIG. 7, node 700 may also include memory 704. Although only one memory is shown, it is understood that multiple memories can be included. Memory 704 can broadly include both memory and storage. For example, memory 704 may include random-access memory (RAM), read-only memory (ROM), static RAM (SRAM), dynamic RAM (DRAM), ferro-electric RAM (FRAM), electrically erasable programmable ROM (EEPROM), CD-ROM or other optical disk storage, hard disk drive (HDD), such as magnetic disk storage or other magnetic storage devices, Flash drive, solid-state drive (SSD), or any other medium that can be used to carry or store desired program code in the form of instructions that can be accessed and executed by processor 702. Broadly, memory 704 may be embodied by any computer-readable medium, such as a non-transitory computer-readable medium.

Processor 702, memory 704, and transceiver 706 may be implemented in various forms in node 700 for performing wireless communication functions. In some embodiments, processor 702, memory 704, and transceiver 706 of node 700 are implemented (e.g., integrated) on one or more system-on-chips (SoCs). In one example, processor 702 and memory 704 may be integrated on an application processor (AP) SoC (sometimes known as a “host,” referred to herein as a “host chip”) that handles application processing in an operating system (OS) environment, including generating raw data to be transmitted. In another example, processor 702 and memory 704 may be integrated on a baseband processor (BP) SoC (sometimes known as a “modem,” referred to herein as a “baseband chip”) that converts the raw data, e.g., from the host chip, to signals that can be used to modulate the carrier frequency for transmission, and vice versa, which can run a real-time operating system (RTOS). In still another example, processor 702 and transceiver 706 (and memory 704 in some cases) may be integrated on an RF SoC (sometimes known as a “transceiver,” referred to herein as an “RF chip”) that transmits and receives RF signals with antenna 708. It is understood that in some examples, some or all of the host chip, baseband chip, and RF chip may be integrated as a single SoC. For example, a baseband chip and an RF chip may be integrated into a single SoC that manages all the radio functions for cellular communication.

Referring back to FIG. 1, in some embodiments, any suitable node of wireless network 100 (e.g., user equipment 102 or access node 104) in transmitting signals to another node, for example, from user equipment 102 to access node 104, or vice versa, via a downlink (DL), may process Layer 2 data in an in-line manner using dedicated Layer 2 circuits (sometimes controlled by an MCU) on a baseband chip, as described below in detail. As a result, compared with known solutions in which Layer 2 data is processed using software modules implemented on a generic processor in conjunction with the system memory, the data speed can be improved due to hardware acceleration, the chip cost can be reduced by reducing memory usage, and the power consumption can be decreased as well.

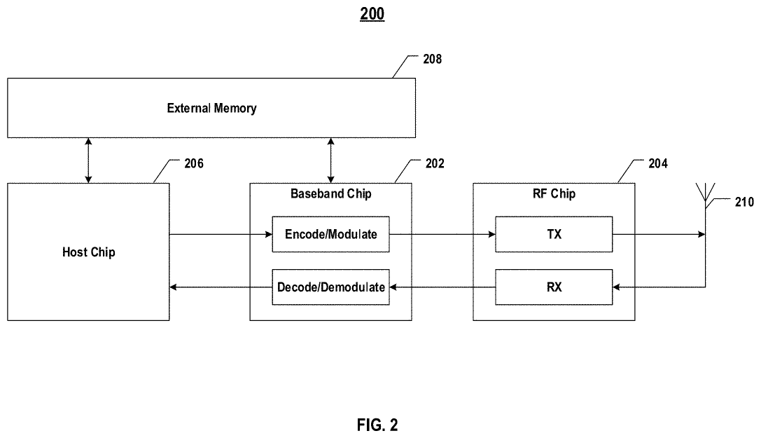

FIG. 2 illustrates a block diagram of an apparatus 200 including a baseband chip 202, an RF chip 204, and a host chip 206, according to some embodiments of the present disclosure. Apparatus 200 may be an example of any suitable node of wireless network 100 in FIG. 1, such as user equipment 102 or access node 104. As shown in FIG. 2, apparatus 200 may include baseband chip 202, RF chip 204, host chip 206, and one or more antennas 210. In some embodiments, baseband chip 202 is implemented by processor 702 and memory 704, and RF chip 204 is implemented by processor 702, memory 704, and transceiver 706, as described above with respect to FIG. 7. Besides the on-chip memory (also known as “internal memory,” e.g., registers, buffers, or caches) on each chip 202, 204, or 206, apparatus 200 may further include an external memory 208 (e.g., the system memory or main memory) that can be shared by each chip 202, 204, or 206 through the system/main bus. Although baseband chip 202 is illustrated as a standalone SoC in FIG. 2, it is understood that in one example, baseband chip 202 and RF chip 204 may be integrated as one SoC; in another example, baseband chip 202 and host chip 206 may be integrated as one SoC; in still another example, baseband chip 202, RF chip 204, and host chip 206 may be integrated as one SoC, as described above.

In the uplink, host chip 206 may generate raw data and send it to baseband chip 202 for encoding, modulation, and mapping. Baseband chip 202 may also access the raw data generated by host chip 206 and stored in external memory 208, for example, using the direct memory access (DMA). Baseband chip 202 may first encode (e.g., by source coding and/or channel coding) the raw data and modulate the coded data using any suitable modulation techniques, such as multi-phase pre-shared key (MPSK) modulation or quadrature amplitude modulation (QAM). Baseband chip 202 may perform any other functions, such as symbol or layer mapping, to convert the raw data into a signal that can be used to modulate the carrier frequency for transmission. In the uplink, baseband chip 202 may send the modulated signal to RF chip 204. RF chip 204, through the transmitter (Tx), may convert the modulated signal in the digital form into analog signals, i.e., RF signals, and perform any suitable front-end RF functions, such as filtering, up-conversion, or sample-rate conversion. Antenna 210 (e.g., an antenna array) may transmit the RF signals provided by the transmitter of RF chip 204.

In the downlink, antenna 210 may receive RF signals and pass the RF signals to the receiver (Rx) of RF chip 204. RF chip 204 may perform any suitable front-end RF functions, such as filtering, down-conversion, or sample-rate conversion, and convert the RF signals into low-frequency digital signals (baseband signals) that can be processed by baseband chip 202. In the downlink, baseband chip 202 may demodulate and decode the baseband signals to extract raw data that can be processed by host chip 206. Baseband chip 202 may perform additional functions, such as error checking, de-mapping, channel estimation, descrambling, etc. The raw data provided by baseband chip 202 may be sent to host chip 206 directly or stored in external memory 208.

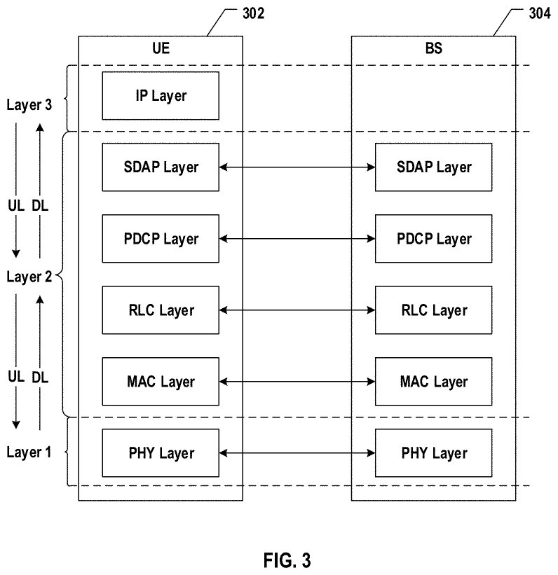

FIG. 3 illustrates a block diagram of an exemplary user plane protocol stack, according to some embodiments of the present disclosure. Baseband chip 202 of a node, either user equipment 102 or access node 104, may implement a protocol stack defined in the standards, for example, by the 3GPP, which includes a set of network protocol layers that work together to provide networking capabilities. According to the 3GPP standards, the radio protocol architecture for both LTE and NR can be separated into the user plane carrying the user traffic and the control plane carrying the signaling traffic. For example, in the user plane, applications may create data packets that are processed by protocols, such as the Transmission Control Protocol (TCP), User Datagram Protocol (UDP), or Interconnect Protocol (IP). In the control plane, signaling messages may be generated by the Radio Resource Control (RRC) protocol. As shown in FIG. 3, each of a user equipment 302 (e.g., an example of user equipment 102 in FIG. 1) and a base station 304 (e.g., an example of access node 104 in FIG. 1) may implement the protocol stack in the user plane for LTE or NR. Each layer is responsible for processing the user plane data packets in the form of IP data or raw user data, ensuring that data transmission is secure, on-time, and error-free.

Layer 3 in LTE or NR user plane may include the IP layer in user equipment 302 for providing user data, for example, in the form of IP data packets. Layer 2 in LTE may consist of the PDCP layer, the RLC layer, and the MAC layer, from higher to lower in the protocol stack. Layer 2 in NR may further include a Service Data Adaptation Protocol (SDAP) layer. The SDAP layer may map between a Qualify of Service (QoS) flow and a data radio bearer (DRB) due to the new QoS framework. That is, the SDAP layer may classify the data packets in QoS flows into DRBs. The SDAP layer may also mark the QoS flow IDs (QFIs) in downlink data packets due to reflective QoS and in uplink data packets due to the new QoS framework.

The PDCP layer in the user plane may perform robust header compression (ROHC) and security functions, such as integrity checking and ciphering, in the uplink, and ROHC decompression and deciphering in the downlink. The PDCP layer may receive the data packets in the form of PDCP service data units (SDUs) from the upper layer, i.e., Layer 3, and pass the processed data in the form of PDCP protocol data units (PDCP PDUs) to the lower layer, e.g., the RLC layer. The PDCP layer may also perform sequence numbering, reordering, duplication detection, PDCP PDU routing, PDCP SDU discard, etc.

The RLC layer in the user plane may segment or concatenate the data packets received from the upper layer, e.g., the PDCP PDUs/RLC SDUs, into each RLC PDU. That is, the RLC layer may pack small data packets together to form a large data packet (e.g., in LTE) or break down a large data packet into multiple smaller data packets. Depending on the mode of operations (e.g., the transparent mode (TM), the unacknowledged mode (UM), or the acknowledged mode (AM)), the RLC layer may further perform error correction through automatic repeat request (ARQ) in the AM mode, reassembly of RLC SDUs in the UM and AM modes, duplication detection in the UM and AM modes, and RLC SDU discard in the UM and AM modes. In some embodiments, the RLC layer performs RLC re-transmission by inserting re-transmitted data packets.

The MAC layer in the user plane may map between logical channels and transport channels. In the uplink, the MAC layer may multiplex MAC SDUs from one or more logical channels onto MAC PDUs to be delivered to the lower layer, i.e., Layer 3, on transport channels. In the uplink, the MAC layer may de-multiplex MAC SDUs from one or different logical channels from transport blocks delivered from the lower layer on transport channels. The MAC layer may also perform scheduling, information reporting, error correction through hybrid ARQ (HARQ), priority handling between user equipments by dynamic scheduling, priority handling between logical channels by logical channel prioritization, and padding.

Layer 1 in LTE or NR includes a physical (PHY) layer, which carries all information received from the MAC layer transport channels, e.g., in the form of transport blocks (TBs), over the air interface in the uplink, and vice versa in the downlink. Layer 1 may also perform link adaptation, power control, cell search (for initial synchronization and handover purposes), and other measurements (inside the same network or between different networks) for the RRC layer.

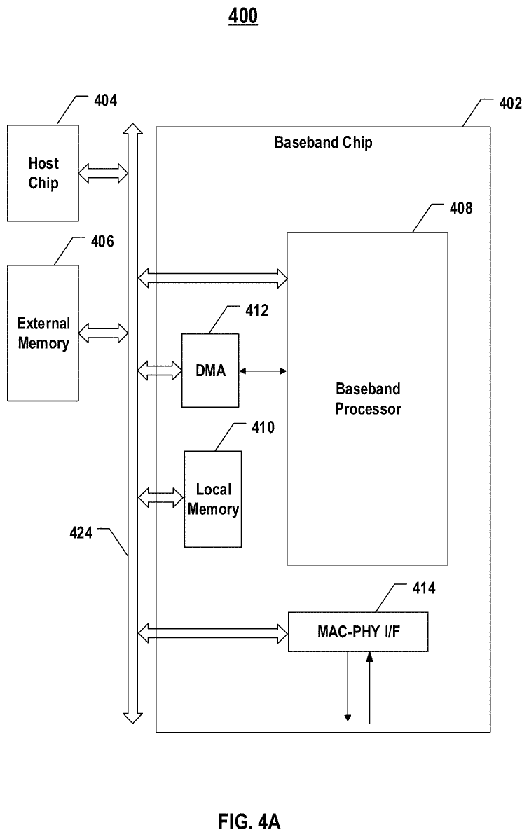

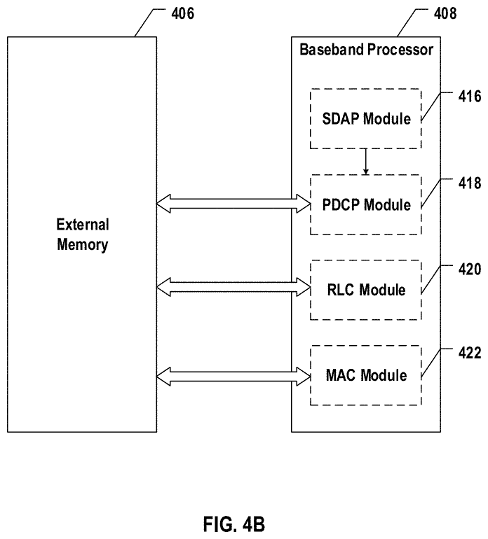

As one example of known solutions implementing Layer 2 downlink data processing using software modules executed by a generic processor, FIG. 4A illustrates a block diagram of a baseband chip 402 implementing Layer 2 downlink data processing using a baseband processor 408, and FIG. 4B illustrates a data flow of baseband chip 402 shown in FIG. 4A. An apparatus 400, such as a user equipment or a base station, includes baseband chip 402, a host chip 404, and an external memory 406 operatively coupled to one another through a main bus 424. Baseband chip 402 includes baseband processor 408, a local memory 410, a DMA 412, and a MAC Layer-to-PHY Layer interface (MAC-PHY I/F) 414, each of which is operatively coupled to external memory 406 through main bus 424.

As shown in FIG. 4B, to perform Layer 2 downlink data processing, a plurality of software modules, including an SDAP module 416, a PDCP module 418, an RLC module, and a MAC module 422, are executed by baseband processor 408, which is a generic processor, such as a CPU or DSP, not dedicated to Layer 2 downlink data processing. Baseband processor 408 is also responsible for any other functions of baseband chip 402 and can be interrupted when performing Layer 2 downlink data processing due to other processes with higher priorities. On the other hand, baseband processor 408 does not process the Layer 2 downlink data in an in-line manner, meaning that the data passing through each module 422, 420, 418, or 416 is not a continuous data flow/stream. For example, the intermediate data packets during the processing, such as the PDCP SDUs, PDCP PDUs/RLC SDUs, RLC PDUs/MAC SDUs, or MAC PDUs, need to be frequently stored into and accessed from external memory 406 (e.g., a system memory) through main bus 424. The outputs of Layer 2 downlink data processing, i.e., the Layer 3 data packets (e.g., IP data packets), are also first sent by baseband processor 408 to external memory 406 and then accessed by Layer 3 (e.g., the IP Layer) from external memory 406 when Layer 3 is ready to receive the Layer 3 data packets. As a result, the software implementation of Layer 2 downlink data processing using a generic processor in conjunction with external memory can reduce the processing speed and increase memory usage and power consumption.

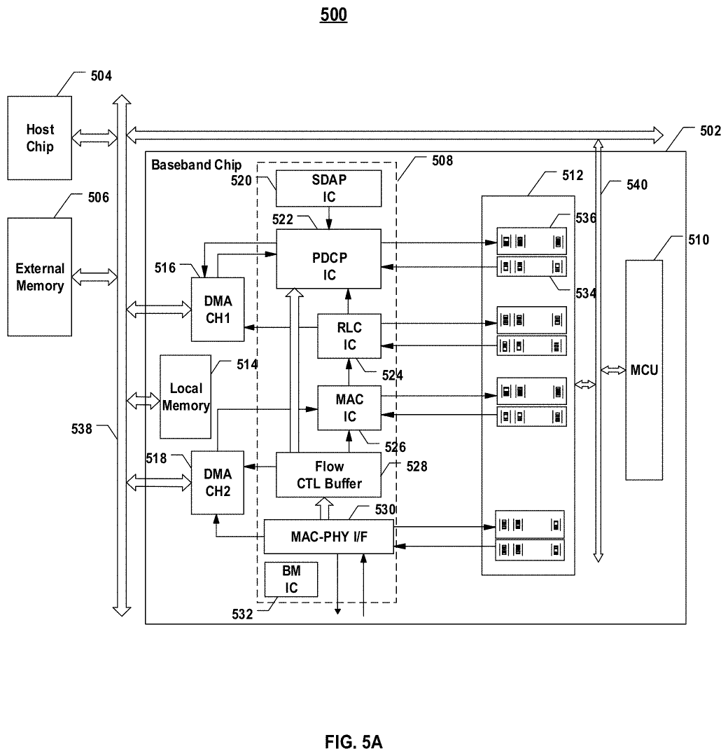

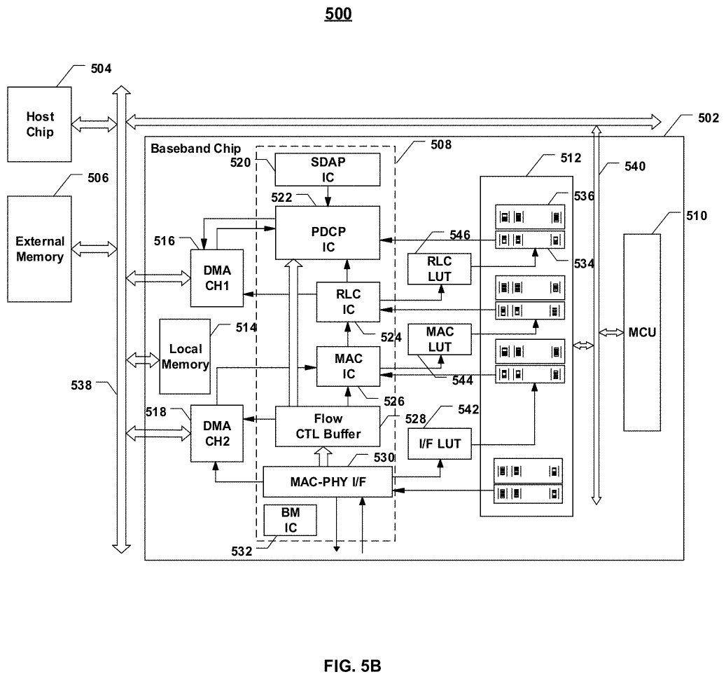

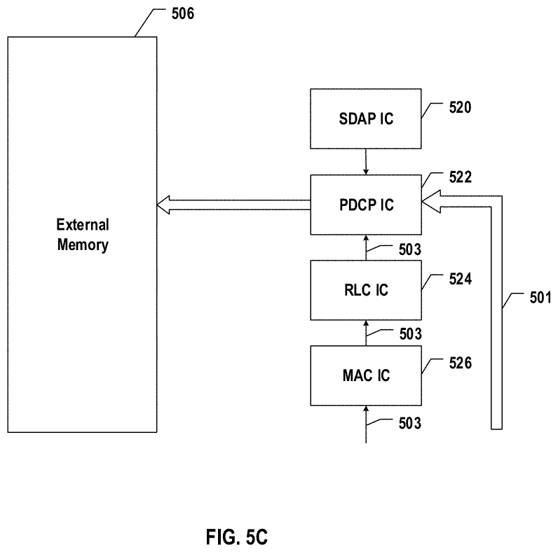

In contrast, FIGS. 5A and 5B illustrate detailed block diagrams of an exemplary baseband chip 502 implementing Layer 2 downlink data processing using Layer 2 circuits 508 and an MCU 510 in an interactive mode and in an automated mode, respectively, according to some embodiments of the present disclosure. FIG. 5C illustrates an exemplary data flow of baseband chip 502 shown in FIGS. 5A and 5B, according to some embodiments of the present disclosure. In some embodiments, Layer 2 circuits 508 include an SDAP circuit 520, a PDCP circuit 522, an RLC circuit 524, and a MAC circuit 526. As described below in detail, the software modules (e.g., SDAP module 416, PDCP module 418, RLC module 420, and MAC module 422) executed by baseband processor 408 in FIG. 4A may be replaced by dedicated integrated circuits (ICs) (e.g., SDAP circuit 520, PDCP circuit 522, RLC circuit 524, and MAC circuit 526) to conduct Layer 2 downlink data processing, thereby improving the performance and reducing the cost. In some embodiments, each of SDAP, PDCP, RLC, and MAC circuits 520, 522, 524, or 526 is an IC dedicated to performing the functions of the respective layer in Layer 2 user plane, as described above with respect to FIG. 3. For example, each of SDAP, PDCP, RLC, and MAC circuits 520, 522, 524, or 526 may be an ASIC, which is customized for a particular use, rather than intended for general-purpose use, and thus, is known for its high speed, small die size, and low power consumption compared with a generic processor.

Baseband chip 502 can work in an interactive mode in which one or more dedicated ICs (e.g., SDAP circuit 520, PDCP circuit 522, RLC circuit 524, and/or MAC circuit 526) are controlled by MCU 510, or work in an automated mode in which MCU 510 may not be involved in controlling the dedicated ICs. Different from Layer 2 uplink process in which the uplink data rate is determined and controlled by apparatus 500 (e.g., user equipment 102) having baseband chip 502, the downlink data rate in Layer 2 downlink process is not determined and controlled by apparatus 500 (e.g., a user equipment 102) having baseband chip 502, but is up to the base station (not shown, e.g., access node 104). Thus, baseband chip 502 of apparatus 500 needs to adapt to whatever speed the base station uses, e.g., the Layer 1 data rate. Otherwise, baseband chip 502 may lose packets and cause performance degradations. In some embodiments, baseband chip 502 works in the interactive mode in which one or more dedicated ICs (e.g., SDAP circuit 520, PDCP circuit 522, RLC circuit 524, and/or MAC circuit 526) and MCU 510 can interact with one another by exchanging control commands and result statuses. In some embodiments, baseband chip 502 works in the automation mode in which the dedicated ICs generate control commands without the intervention of MCU 510. Thus, baseband chip 502 can switch between the interactive mode when the Layer 1 data rate is relatively slow, and the automation mode when the Layer 1 data rate is relatively high.

Apparatus 500 may be any suitable node of wireless network 100 in FIG. 1, such as user equipment 102 or access node 104 (e.g., a base station including eNB in LTE or gNB in NR). As shown in FIGS. 5A and 5B, apparatus 500 may include baseband chip 502, a host chip 504, an external memory 506, and a main bus 538 (also known as a “system bus”) operatively coupling baseband chip 502, host chip 504, and external memory 506. That is, baseband chip 502, host chip 504, and external memory 506 may exchange data through main bus 538. Host chip 504 may be an example of host chip 206 described above in FIG. 2 for generating raw data that has not been coded and modulated yet by the PHY layer of baseband chip 502. In some embodiments, the raw data is formatted into data packets, according to any suitable protocols, such as TCP, UDP, or IP, for example, IP data packets. External memory 506 may be an example of external memory 208 described above in FIG. 2, which can be shared by host chip 504, baseband chip 502, or any other suitable components in apparatus 500, such as a system memory (also known as a “main memory” or “primary memory”) of apparatus 500. In some embodiments, external memory 506 stores the Layer 1 raw data (e.g., transport blocks) to be processed by Layer 2 circuits 508 of baseband chip 502 and stores the processed data generated by Layer 2 circuits 508 (e.g., IP data packets) to be accessed by Layer 1 (e.g., the IP layer). Different from external memory 406 in FIG. 4A, external memory 506 may not store any intermediate data of Layer 2 circuits 508, for example, PDCP PDUs/RLC SDUs or RLC PDUs/MAC SDUs.

As shown in FIGS. 5A and 5B, baseband chip 502 may also include a plurality of direct memory access (DMA) channels including a first DMA channel (DMA CH1) 516 and a second DMA channel (DMA CH2) 518. Each DMA channel 516 or 518 can allow certain Layer 2 circuits 508 to access external memory 506 directly independent of host chip 504. In some embodiments, DMA channels 516 and 518 may include a DMA controller and any other suitable input/output (I/O) circuits. As shown in FIGS. 5A and 5B, baseband chip 502 may further include a local memory 514, such as an on-chip memory on baseband chip 502, which is distinguished from external memory 506 that is an off-chip memory not on baseband chip 502. In some embodiments, local memory 514 includes one or more L1, L2, L3, or L4 caches. Layer 2 circuits 508 may access local memory 514 through main bus 538 as well.

As shown in FIGS. 5A and 5B, baseband chip 502 may further include a memory 512 that can be shared by (e.g., both accessed by) Layer 2 circuits 508 and MCU 510. It is understood that although memory 512 is shown as an individual memory separate from local memory 514, in some examples, memory 512 and local memory 514 may be local partitions of the same physical memory structure, for example, an SRAM. In one example, a logical partition in local memory 514 may be dedicated to or dynamically allocated to Layer 2 circuits 508 and MCU 510 for exchanging control commands and result statuses when baseband chip 502 is in the interactive mode. In some embodiments, memory 512 includes a plurality of command queues 534 for storing a plurality sets of commands, respectively, and a plurality of status queues 536 for storing a plurality sets of result statuses, respectively. Each pair of corresponding command queue 534 and status queue 536 may be dedicated to one of Layer 2 circuits 508, as described below in detail with respect to FIG. 5A when baseband chip 502 works in the interactive mode.

As shown in FIGS. 5A and 5B, baseband chip 502 may further include a local bus 540. In some embodiments, MCU 510 is operatively coupled to memory 512 and main bus 538 through local bus 540. As described below in detail with respect to FIG. 5A when baseband chip 502 works in the interactive mode, MCU 510 may be configured to generate a plurality sets of control commands and store each set of the commands into respective command queue 534 in memory 512 through local bus 540 and interrupts. MCU 510 may also receive a plurality sets of result statuses from status queues 536 in memory 512, respectively, through local bus 540 and interrupts. In some embodiments, MCU 510 generates a set of commands based on a set of result statuses from a lower layer in the Layer 2 protocol stack (e.g., the previous stage in Layer 2 downlink processing). Through the control commands in commands queues 534 in memory 512, MCU 510 can be operatively coupled to Layer 2 circuits 508 and control the operations of Layer 2 circuits 508 to process the Layer 2 downlink data. It is understood that although one MCU 510 is shown in FIG. 5A, the number of MCUs is scalable, such that multiple MCUs may be used in some examples. It is also understood that in some embodiments, memory 512 may be part of MCU 510, e.g., a cache integrated with MCU 510. It is further understood that regardless of the naming, any suitable processing units that can generate control commands to control the operations of Layer 2 circuits 508 and check the result statuses of Layer 2 circuits 508 may be considered as MCU 510 disclosed herein.

Referring to Layer 2 circuits 508, Layer 2 circuits 508 may be configured to receive Layer 1 transport blocks (as the inputs of Layer 2 circuits 508) and generate Layer 3 data packets (as the outputs of Layer 2 circuits 508) from the Layer 1 transport blocks in an in-line manner. In some embodiments, Layer 2 circuits 508 are configured to pass data (e.g., the Layer 1 transport blocks) through each layer of Layer 2 circuits 508 without storing the data (e.g., the Layer 1 transport blocks) in external memory 506, as shown in FIG. 5C. The data may flow from lower to upper layers in Layer 2 (e.g., MAC circuit 526, RLC circuit 524, and PDCP circuit 522).

As shown in FIG. 5A in which baseband chip 502 works in the interactive mode, MCU 510 may be operatively coupled to Layer 2 circuits 508 and configured to control Layer 2 circuits 508 to generate Layer 3 data packets from the Layer 1 transport blocks through a plurality sets of commands. In some embodiments, besides SDAP circuit 520, PDCP circuit 522, RLC circuit 524, and MAC circuit 526, each of which corresponds to one layer in Layer 2 user plane in LTE or NR, Layer 2 circuits 508 includes additional hardware components including a flow control buffer 528, a MAC-PHY interface 530, and a buffer management (BM) circuit 532.

As shown in FIG. 5A, MAC-PHY interface 530 may be operatively coupled to flow control buffer 528 and configured to receive the Layer 1 transport blocks from Layer 1 (e.g., the PHY layer). The operations of MAC-PHY interface 530 may be controlled based on a set of interface commands from MCU 510. In some embodiment, MCU 510 is configured to generate a set of interface commands and store/write the set of interface commands into an interface command queue 534 in memory 512, such that MAC-PHY interface 530 retrieves/reads the set of interface commands from interface command queue 534 according to the priorities assigned by MCU 510 to the interface commands. Each Layer 1 transport block may contain data from the previous radio subframe, having multiple or partial packets, depending on scheduling and modulation. Each Layer 1 transport block may correspond to a MAC PDU and include a payload (e.g., having encrypted data) and multiple headers (e.g., MAC header, RLC header, and PDCP header).

In some embodiments, each Layer 1 transport block is divided into a plurality of code blocks (CBs), and MAC-PHY interface 530 receives the Layer 1 transport blocks in the unit of each code block through code block-related signals, such as CB_DATA indicative of the data values of a code block, CB_START indicative of the start of a new code block, CB_LENGTH indicative of the length of the code block, and CB_INDEX indicative of the order number of the code block in the received transport block. MAC-PHY interface 530 may also receive status signals, for example, DATA_READY indicative of a valid cycle of received packet data and TB_ID indicative of the index of the transport block. In some embodiments, the interface control commands from MCU 510 are generated based at least in part on one or more of the signals received by MAC-PHY interface 530. MAC-PHY interface 530 may be further configured to obtain the processing result, for example, once the MAC-PHY interface processing is completed, halted, or interrupted, and store a set of result statuses indicative of the processing result into an interface status queue 536 in memory 512. For example, each Layer 1 transport block of each code block of a transport block received by MAC-PHY interface 530 may cause a trigger to MCU 510 to start control SDAP circuit 520, PDCP circuit 522, RLC circuit 524, and/or MAC circuit 526 to perform the corresponding Layer 2 downlink data process function.

As shown in FIG. 5A, flow control buffer 528 may be operatively coupled to MAC-PHY interface 530 and configured store the Layer 1 transport blocks received by MAC-PHY interface 530. Flow control buffer 528 may be a separate physical memory component or part of local memory 514 (e.g., a logical partition thereof) dedicated to Layer 2 downlink data processing. In some embodiments, flow control buffer 528 is further configured to buffer the Layer 1 transport blocks to be adapted to Layer 1 data rate, for example, when the Layer 1 data rate exceeds the peak Layer 2 downlink data processing capability of baseband chip 502. Different from the known solutions (e.g., in FIG. 4B) in which external memory 406 is used for buffering the data in Layer 2 downlink data processing, Layer 2 circuits 508 in baseband chip 502 perform Layer 2 downlink data processing in an in-line manner without access to external memory 506. In order to adapt the higher Layer 1 data rate, flow control buffer 528 may perform the MAC-PHY flow control function by buffering the Layer 1 transport blocks. It is understood that in some examples, second DMA channel 518 operatively coupled to flow control buffer 528 and MAC-PHY interface 530 may be configured to transmit some of the Layer 1 transport blocks from flow control buffer 528 or directly through MAC-PHY interface 530 to external memory 506 to overflow the Layer 1 transport blocks when the capacity of flow control buffer 528 is overloaded, for example, by an extremely high Layer 1 data rate.

Besides Layer 1 data rate adaptation, flow control buffer 528 can be used for code block re-organization as well when the received code blocks are not in order. Moreover, as described below in detail, the payload and headers of each Layer 1 transport block can be processed separately to reduce the workload and power consumption of baseband chip 502. In some embodiments, the payload of a Layer 1 transport block is stored in flow control buffer 528 until the headers of the Layer 1 transport block have been processed by Layer 2 circuits 508 (e.g., MAC circuit 526, RLC circuit 524, and/or PDCP circuit 522).

As shown in FIG. 5A, MAC circuit 526 may be operatively coupled to flow control buffer 528 and RLC circuit 524 and configured to process the MAC headers of the Layer 1 transport blocks received from flow control buffer 528. The processing of the MAC headers by MAC circuit 526 may be controlled based on a set of MAC commands from MCU 510. In some embodiment, MCU 510 is configured to retrieve/read the set of interface result statuses (i.e., the result statues from MAC-PHY interface 530) from interface status queue 536, generate the set of MAC commands based on the set of interface result statuses, and store/write the set of MAC commands into a MAC command queue 534 in memory 512, such that MAC circuit 526 can retrieve/read the set of MAC commands from MAC command queue 534 according to the priorities assigned by MCU 510 to the MAC commands. For example, the MAC commands may need to be adjusted based on the processing result at MAC-PHY interface 530, e.g., wait until all the code blocks of the next Layer 1 transport block have been received and organized in order in flow control buffer 528. In some embodiments, MAC circuit 526 is configured to process only the MAC header, but not the payload of a Layer 1 transport block stored in flow control buffer 528. For example, MAC circuit 526 may extract the MAC header from the Layer 1 transport block and read only the MAC header, but not the payload, of the Layer 1 transport block. It is understood that in some examples, MAC circuit 526 may extract and read other headers of the Layer 1 transport block as well, such as RLC header and PDCP header. Nevertheless, MAC circuit 526 does not read the payload of the Layer 1 transport block, and does not process other headers, such as RLC header and PDCP headers, according to some embodiments.

In some embodiments, the functions of MAC circuit 526 in processing the MAC headers are defined by the 3GPP standards as described above with respect to the MAC Layer in FIG. 3. For example, MAC circuit 526 may perform HARQ, MAC downlink mapping, and/or MAC format selection and measurement by processing the MAC headers of the Layer 1 transport blocks, which are extracted and read from flow control buffer 528. It is understood that in case any update or change being made to the required functions of the MAC Layer, MCU 510 may reflect the update or change in its MAC commands to control MAC circuit 526 to act accordingly. As shown in FIG. 5A, MAC circuit 526 may be further configured to obtain the processing result, for example, once the MAC header processing is completed, halted, or interrupted, and store a set of result statuses indicative of the processing result into a MAC status queue 536 in memory 512.

As shown in FIG. 5A, RLC circuit 524 may be operatively coupled to MAC circuit 526 and PDCP circuit 522 and configured to process the RLC headers of the Layer 1 transport blocks received from MAC circuit 526. The processing of the RLC headers may be controlled based on a set of RLC commands from MCU 510. In some embodiment, MCU 510 is configured to retrieve/read the set of MAC result statuses (i.e., the result statues from the lower layer—MAC Layer—in the Layer 2 protocol stack) from MAC status queue 536, generate the set of RLC commands based on the set of MAC result statuses, and store/write the set of RLC commands into an RLC command queue 534 in memory 512, such that RLC circuit 524 can retrieve/read the set of RLC commands from RLC command queue 534 according to the priorities assigned by MCU 510 to the RLC commands. For example, the RLC commands may need to be adjusted based on the processing result at the lower layer, i.e., the MAC layer by MAC circuit 526, e.g., wait until the MAC header of a Layer 1 transport block has been processed and/or the RLC header of the Layer 1 transport block has been extracted and read from flow control buffer 528 by MAC circuit 526.

Similar to MAC circuit 526, in some embodiments, RLC circuit 524 is configured to process only the RLC header, but not the payload of a Layer 1 transport block stored in flow control buffer 528. For example, MAC circuit 526 may extract and read the MAC and RLC headers of the Layer 1 transport block stored in flow control buffer 528, and RLC circuit 524 may receive the RLC header from MAC circuit 526. It is understood that in some examples, RLC circuit 524 may extract and read the RLC header of the Layer 1 transport block from flow control buffer 528 directly. Nevertheless, RLC circuit 524 does not read the payload of the Layer 1 transport block, and does not process other headers, such as MAC header and PDCP headers, according to some embodiments. That is, in some embodiments, none of MAC circuit 526 and RLC circuit 524 processes the payloads of the Layer 1 transport blocks stored in flow control buffer 528.

In some embodiments, the functions of RLC circuit 524 in processing the RLC headers are defined by the 3GPP standards as described above with respect to the RLC Layer in FIG. 3. For example, RLC circuit 524 may perform segmentation, reassembly, duplication detection, and/or in-order delivery in three modes by processing the RLC headers of the Layer 1 transport blocks, which are extracted and read from flow control buffer 528. It is understood that in case any update or change being made to the required functions of the RLC Layer, MCU 510 may reflect the update or change in its RLC commands to control RLC circuit 524 to act accordingly. As shown in FIG. 5A, RLC circuit 524 may be further configured to obtain the processing result, for example, once the RLC Layer processing is completed, halted, or interrupted, and store a set of result statuses indicative of the processing result into an RLC status queue 536 in memory 512. For example, RLC circuit 524 may process the RLC header to check whether the sequence number is continuous and report the missing sequence numbers to MCU 510 as part of its result statuses in the form of a bitmap in memory 512 within the RLC re-ordering window. Alternatively, RLC circuit 524 may report the received sequence numbers to MCU 510 in the form of entries as part of its result statuses.

As shown in FIG. 5A, PDCP circuit 522 may be operatively coupled to RLC circuit 524 and SDAP circuit 520 and configured to process the PDCP headers of the Layer 1 transport blocks received from RLC circuit 524. The processing of the PDCP headers may be controlled based on a set of PDCP commands from MCU 510. In some embodiment, MCU 510 is configured to retrieve/read the set of RLC result statuses (i.e., the result statues from the lower layer—RLC Layer—in the Layer 2 protocol stack) from RLC status queue 536, generate the set of PDCP commands based on the set of RLC result statuses, and store/write the set of PDCP commands into a PDCP command queue 534 in memory 512, such that PDCP circuit 522 can retrieve/read the set of PDCP commands from PDCP command queue 534 according to the priorities assigned by MCU 510 to the PDCP commands. For example, the PDCP commands may need to be adjusted based on the processing result at the lower layer, i.e., the RLC layer by RLC circuit 524, e.g., wait until the RLC header of a Layer 1 transport block has been processed and/or the PDCP header of the Layer 1 transport block has been extracted and read from flow control buffer 528 by RLC circuit 524.

In some embodiments, PDCP circuit 522 is configured to process the PDCP header before reading and processing the payload of a Layer 1 transport block received from flow control buffer 528. For example, MAC circuit 526 may extract and read the MAC, RLC, and PDCP headers of the Layer 1 transport block stored in flow control buffer 528, RLC circuit 524 may receive the RLC and PDCP headers from MAC circuit 526, and PDCP circuit 522 may receive the PDCP header from RLC circuit 524. It is understood that in some examples, PDCP circuit 522 may extract and read the PDCP header of the Layer 1 transport block from flow control buffer 528 directly.

After processing the PDCP header, PDCP circuit 522 may be configured to process the payload of the Layer 1 transport block received from flow control buffer 528. In some embodiments, the processing of the payload is based, at least in part, on the processed PDCP header of the Layer 1 transport block and thus, is performed after the processing of the PDCP header. In some embodiments, the processing of the payload is based, at least in part, on the processed RLC header and/or the processed MAC header of the Layer 1 transport block as well. It is understood that in some examples, the processing of the PDCP header and the processing of the RLC header may be performed independently and/or simultaneously. Nevertheless, PDCP circuit 522 is the driving stage that start to pull payloads out of flow control buffer 528 and is the only Layer 2 circuit 508 that processes the payloads of the Layer 1 transport blocks, according to some embodiments. In some embodiments, PDCP circuit 522 may be configured to generate a Layer 3 data packet based on the processed PDCP header and payloads of the Layer 1 transport block. In some embodiments, the Layer 3 data packet is generated based on the processed RLC header and/or MAC header as well.

In some embodiments, the functions of PDCP circuit 522 in processing the PDCP headers, payloads, and generating the Layer 3 data packets are defined by the 3GPP standards as described above with respect to the PDCP Layer in FIG. 3. For example, PDCP circuit 522 may perform ROHC header decompression, deciphering, decryption, re-ordering, sequence numbering, duplicate removal, and/or integrity protection. It is understood that in case any update or change being made to the required functions of the PDCP Layer, MCU 510 may reflect the update or change in its PDCP commands to control PDCP circuit 522 to act accordingly. As shown in FIG. 5A, PDCP circuit 522 may be further configured to obtain the processing result, for example, once the PDCP Layer processing is completed, halted, or interrupted, and store a set of result statuses indicative of the processing result into a PDCP status queue 536 in memory 512.

As shown in FIG. 5C, payload 501 and the headers 503 of Layer 1 transport blocks may be separately read and processed by Layer 2 circuits 508 (MAC circuit 526, RLC circuit 524, and PDCP circuit 522) in different routes as described above in detail. For example, headers 503 may be extracted together and sent upstream to each Layer circuit 508, accordingly. That is, headers 503 may be processed in-place without reading the entire Layer 1 transport block. Once headers 503 are processed by Layer 2 circuits 508, respectively, payload 501 then may be read and processed by PDCP circuit 522, but not MAC circuit 526 and RLC circuit 524, as described above in detail.

In NR, SDAP circuit 520 may be configured to cause PDCP circuit 522 to organize the Layer 3 data packets based on QoS. For example, SDAP circuit 520 may function as a lookup table (LUT) that maps between a QoS flow of the Layer 3 data packets and a DRB. That is, SDAP circuit 520 may classify the Layer 3 data packets in QoS flows into DRBs. SDAP circuit 520 may also mark the QoS flow ID (QFIs) in the Layer 3 data packets. As shown in FIG. 5C, SDAP circuit 520 may not process the data flow directly, but instead, monitor and cause PDCP circuit 522 to organize the data flow being processed by PDCP circuit 522.

Moreover, any additional functions of Layer 2 downlink data processing implemented in known solutions using software modules executed by a generic processor may be replaced by a hardware component, such as an ASIC, as part of Layer 2 circuits 508 in baseband chip 502. In some embodiments, buffer management circuit 532 is configured to manage the logical partitions of local memory 514 by dynamically dividing, allocating, and releasing local memory 514 into buffers used as, for example, memory 512 or flow control buffer 528. In some embodiments, buffer management circuit 532 is also configured to manage the buffer for re-transmission.

By controlling the operations of Layer 2 circuits 508 based on the processing results at the lower layer using MCU 510, the operations of Layer 2 circuits 508 can be dynamically updated by MCU 510 in view of the real-time processing results in the interactive mode. Moreover, the functions of Layer 2 circuits 508 can also be easily expanded and updated by programming MCU 510 as needed in the interactive mode. On the other hand, to increase the peak processing capability of baseband chip 502 in handling a very high Layer 1 data rate, baseband chip 502 can work in the automated mode, as shown in FIG. 5B. Different from the interactive mode in which each set of commands for controlling a respective Layer 2 circuit 508 is generated by MCU 510, in the automated mode, each Layer 2 circuit 508 can generate a set of commands for controlling another Layer 2 circuit 508 in the upper layer of the Layer 2 protocol stack. In other words, Layer 2 circuits 508 may be operated in a full hardware acceleration mode without interaction with MCU 510. The control commands can be derived from the headers of the protocol layers. In other words, the header of a lower layer in the Layer 2 protocol stack can be decoded to generate control commands for Layer 2 circuit 508 in the upper layer.

As shown in FIG. 5B, MAC-PHY interface 530 may be configured to receive the Layer 1 transport blocks and forward the Layer 1 transport blocks to flow control buffer 528. MAC-PHY interface 530 may be further configured to generate a set of MAC commands based on information related to the Layer 1 transport blocks and an interface lookup table (LUT) circuit 542. The information related to the Layer 1 transport blocks may include, for example, the status signals indicative of, for example, the start, length, and ID of each transport block or code block therein, and the validity of the data. Interface LUT circuit 542 may index or map the information related to the Layer 1 transport blocks to corresponding MAC commands. In some embodiments, interface LUT circuit 542 is a hardware lookup table implemented with a multiplexer of which select lines are driven by the address signal and of which inputs are the values of the elements contained in the index or map. These values can either be hard-wired, as in an ASIC or provided by D latches. In some embodiments, MAC-PHY interface 530 stores/writes the set of MAC commands into MAC command queue 534 in memory 512, such that MAC circuit 526 can retrieve/read the set of MAC commands from MAC command queue 534 according to the priorities assigned by MAC-PHY interface 530 to the MAC commands.

As shown in FIG. 5B, MAC circuit 526 may be configured to process the MAC headers based on the set of MAC commands, and generate a set of RLC commands based on the processed MAC headers and a MAC LUT circuit 544. MAC circuit 526 may decode the MAC header and derive RLC commands from the MAC header. MAC LUT circuit 544 may index or map the information decoded and derived from the MAC headers to corresponding RLC commands. In some embodiments, MAC LUT circuit 544 is a hardware lookup table implemented with a multiplexer of which select lines are driven by the address signal and of which inputs are the values of the elements contained in the index or map. These values can either be hard-wired, as in an ASIC or provided by D latches. In some embodiments, MAC circuit 526 stores/writes the set of RLC commands into RLC command queue 534 in memory 512, such that RLC circuit 524 can retrieve/read the set of RLC commands from RLC command queue 534 according to the priorities assigned by MAC circuit 526 to the RLC commands.

As shown in FIG. 5B, RLC circuit 524 may be configured to process the RLC headers based on the set of RLC commands and generate a set of PDCP commands based on the processed RLC headers and an RLC LUT circuit 546. RLC circuit 524 may decode the RLC header and derive PDCP commands from the MAC header. RLC LUT circuit 546 may index or map the information decoded and derived from the RLC headers to corresponding PDCP commands. In some embodiments, RLC LUT circuit 546 is a hardware lookup table implemented with a multiplexer of which select lines are driven by the address signal and of which inputs are the values of the elements contained in the index or map. These values can either be hard-wired, as in an ASIC, or provided by D latches. In some embodiments, RLC circuit 524 stores/writes the set of PDCP commands into PDCP command queue 534 in memory 512, such that PDCP circuit 522 can retrieve/read the set of PDCP commands from PDCP command queue 534 according to the priorities assigned by RLC circuit 524 to the PDCP commands.

It is understood that baseband chip 502 may work in a hybrid mode in which some of Layer 2 circuits 508 interact with MCU 510, like in the interactive mode, while some other Layer 2 circuits 508 are automated without interacting with MCU 510, like in the automated mode. For example, in FIG. 5B, the set of RLC commands may be generated by MCU 510, instead of MAC circuit 526, such that RLC circuit 524 may be controlled by interactions with MCU 510, as opposed to by MAC circuit 526.

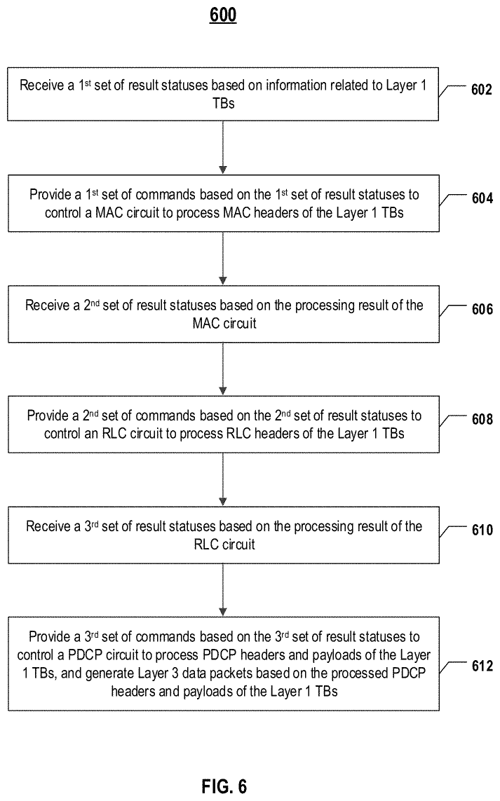

FIG. 6 illustrates a flow chart of an exemplary method 600 for Layer 2 downlink data processing, according to some embodiments of the present disclosure. Examples of the apparatus that can perform operations of method 600 include, for example, baseband chip 502 depicted in FIG. 5A in the interactive mode or any other suitable apparatus disclosed herein. It is understood that the operations shown in method 600 are not exhaustive and that other operations can be performed as well before, after, or between any of the illustrated operations. Further, some of the operations may be performed simultaneously, or in a different order than shown in FIG. 6.

Referring to FIG. 6, method 600 starts at operation 602, in which a first set of result statuses based on information related to Layer 1 transport blocks is received by an MCU. In some embodiments, the first set of result statuses is retrieved/read from a corresponding status queue in the memory. As shown in FIG. 5A, MCU 510 may receive/read the set of interface result statuses indicative of the processing result of MAC-PHY interface 530. For example, MCU 510 may retrieve/read the set of interface result statuses from interface status queue 536 in memory 512.

Method 600 proceeds to operation 604, as illustrated in FIG. 6, in which a first set of commands based on the first set of result statuses is provided by the MCU to control a MAC circuit to process MAC headers of the Layer 1 transport blocks. In some embodiments, priorities are assigned to each of the commands in the first set of commands. In some embodiments, the first set of commands are stored into a first command queue in a memory. As shown in FIG. 5A, MCU 510 in baseband chip 502 may generate a set of MAC commands based on the set of interface result statuses and provide the set of MAC commands having priorities to control MAC circuit 526 to process the MAC headers of the Layer 1 transport blocks. MCU 510 may store/write the MAC commands into MAC command queue 534 in memory 512, such that MAC circuit 526 may retrieve/read and execute the MAC commands from MAC command queue 534 based on the priorities of the MAC commands. That is, MCU 510 may control the operations of MAC circuit 526 through the set of MAC commands.

Method 600 proceeds to operation 606, as illustrated in FIG. 6, in which a second set of result statuses based on the processing result of the MAC circuit is received by the MCU. In some embodiments, the second set of result statuses is retrieved/read from a corresponding status queue in the memory. As shown in FIG. 5A, MCU 510 may receive the set of MAC result statuses indicative of the processing result of MAC circuit 526. For example, MCU 510 may retrieve/read the set of MAC result statuses from MAC status queue 536 in memory 512.

Method 600 proceeds to operation 608, as illustrated in FIG. 6, in which a second set of commands based on the second set of result statuses is provided by the MCU to control an RLC circuit to process RLC headers of the Layer 1 transport blocks. In some embodiments, priorities are assigned to each of the commands in the second set of commands. In some embodiments, the second set of commands are stored into a second command queue in a memory. As shown in FIG. 5A, MCU 510 in baseband chip 502 may generate a set of RLC commands based on the set of MAC result statuses and provide the set of RLC commands having priorities to control RLC circuit 524 to process the RLC headers of the Layer 1 transport blocks. MCU 510 may store/write the RLC commands into RLC command queue 534 in memory 512, such that RLC circuit 524 may retrieve/read and execute the RLC commands from RLC command queue 534 based on the priorities of the RLC commands. That is, MCU 510 may control the operations of RLC circuit 524 through the set of RLC commands.

Method 600 proceeds to operation 610, as illustrated in FIG. 6, in which a third set of result statuses based on the processing result of the RLC circuit is received by the MCU. In some embodiments, the third set of result statuses is retrieved/read from a corresponding status queue in the memory. As shown in FIG. 5A, MCU 510 may receive the set of RLC result statuses indicative of the processing result of RLC circuit 524. For example, MCU 510 may retrieve/read the set of RLC result statuses from RLC status queue 536 in memory 512.

Method 600 proceeds to operation 612, as illustrated in FIG. 6, in which a third set of commands based on the third set of result statuses is provided by the MCU to control a PDCP circuit to process PDCP headers and payloads of the Layer 1 transport blocks and generate Layer 3 data packets based on the processed PDCP headers and payloads of the Layer 1 transport blocks. In some embodiments, priorities are assigned to each of the commands in the third set of commands. In some embodiments, the third set of commands are stored into a third command queue in a memory. As shown in FIG. 5A, MCU 510 in baseband chip 502 may generate a set of PDCP commands based on the set of RLC result statuses and provide the set of PDCP commands having priorities to control PDCP circuit 522 to process the PDCP headers and payloads of the Layer 1 transport blocks. MCU 510 may store/write the PDCP commands into PDCP command queue 534 in memory 512, such that PDCP circuit 522 may retrieve/read and execute the PDCP commands from PDCP command queue 534 based on the priorities of the PDCP commands. That is, MCU 510 may control the operations of PDCP circuit 522 through the set of PDCP commands.

In various aspects of the present disclosure, the functions described herein may be implemented in hardware, software, firmware, or any combination thereof. If implemented in software, the functions may be stored on or encoded as instructions or code on a non-transitory computer-readable medium. Computer-readable media includes computer storage media. Storage media may be any available media that can be accessed by a computing device, such as node 700 in FIG. 7. By way of example, and not limitation, such computer-readable media can include RAM, ROM, EEPROM, CD-ROM or other optical disk storage, HDD, such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, includes CD, laser disc, optical disc, DVD, and floppy disk where disks usually reproduce data magnetically, while discs reproduce data optically with lasers. Combinations of the above should also be included within the scope of computer-readable media.

According to one aspect of the present disclosure, a baseband chip includes a plurality of Layer 2 circuits and an MCU operatively coupled to the Layer 2 circuits. The Layer 2 circuits are configured to receive Layer 1 transport blocks and generate Layer 3 data packets from the Layer 1 transport blocks in an in-line manner. The MCU is configured to control, through a plurality sets of commands, at least one of the Layer 2 circuits to generate the Layer 3 data packets from the Layer 1 transport blocks.

In some embodiments, the Layer 2 circuits include an interface configured to receive the Layer 1 transport blocks based on a set of interface commands from the MCU, and a buffer operatively coupled to the interface and configured to store the Layer 1 transport blocks.

In some embodiments, the buffer is further configured to buffer the Layer 1 transport blocks to be adapted to Layer 1 data rate.

In some embodiments, the Layer 2 circuits further include a MAC circuit operatively coupled to the buffer and configured to process MAC headers of the Layer 1 transport blocks received from the buffer based on a set of MAC commands from the MCU, and an RLC circuit operatively coupled to the MAC circuit and configured to process RLC headers of the Layer 1 transport blocks received from the MAC circuit based on a set of RLC commands from the MCU.

In some embodiments, none of the MAC circuit and the RLC circuit processes payloads of the Layer 1 transport blocks stored in the buffer.

In some embodiments, the Layer 2 circuits further include a PDCP circuit operatively coupled to the RLC circuit and the buffer and configured to, based on a set of PDCP commands from the MCU, process PDCP headers of the Layer 1 transport blocks received from the RLC circuit, process payloads of the Layer 1 transport blocks received from the buffer, and generate the Layer 3 data packets based on the processed PDCP headers and payloads of the Layer 1 transport blocks.

In some embodiments, the Layer 2 circuits further include an SDAP circuit configured to cause the PDCP circuit to organize the Layer 3 data packets based on QoS.

In some embodiments, each of the SDAP, PDCP, RLC, and MAC circuits is an ASIC.

In some embodiments, the baseband chip further includes a memory operatively coupled to the MCU and the Layer 2 circuits and configured to store the plurality sets of commands into a plurality of command queues to be fetched by the at least one of the Layer 2 circuits, respectively.

In some embodiments, the memory is further configured to receive a plurality sets of result statuses from the at least one of the Layer 2 circuits, and store the plurality sets of result statuses into a plurality of status queues, respectively.

In some embodiments, the MCU is further configured to retrieve the plurality sets of result statuses from the memory, and generate each set of the commands for controlling a respective one of the Layer 2 circuits based on a corresponding set of the result statuses. The corresponding set of the result status can be from another one of the Layer 2 circuits at a lower layer in Layer 2 protocol stack than the respective one of the Layer 2 circuits.

In some embodiments, the Layer 2 circuits are configured to pass the Layer 1 transport blocks through the Layer 2 circuits without storing the Layer 1 transport blocks in an external memory.

According to another aspect of the present disclosure, a baseband chip includes a buffer, a MAC circuit, an RLC circuit, and a PDCP circuit. The buffer is configured to store Layer 1 transport blocks. The MAC circuit is configured to process MAC headers of the Layer 1 transport blocks received from the buffer. The RLC circuit is configured to process RLC headers of the Layer 1 transport blocks received from the MAC circuit. A PDCP circuit is configured to process PDCP headers of the Layer 1 transport blocks received from the RLC circuit, process payloads of the Layer 1 transport blocks received from the buffer, and generate Layer 3 data packets based on the processed PDCP headers and payloads of the Layer 1 transport blocks.

In some embodiments, each of the PDCP, RLC, and MAC circuits is an ASIC.

In some embodiments, the baseband chip further includes an interface configured to receive the Layer 1 transport blocks, and forward the Layer 1 transport blocks to the buffer, and based on information related to the Layer 1 transport blocks and an interface LUT circuit, generate a set of MAC commands. In some embodiments, the MAC circuit is configured to process the MAC headers based on the set of MAC commands.

In some embodiments, the MAC circuit is further configured to, based on the processed MAC headers and a MAC LUT circuit, generate a set of RLC commands, and the RLC circuit is configured to process the RLC headers based on the set of RLC commands.

In some embodiments, the RLC circuit is further configured to, based on the processed RLC headers and a PDCP LUT circuit, generate a set of PDCP commands, and the PDCP circuit is configured to, based on the set of PDCP commands, process the PDCP headers and the payloads and generate the Layer 3 data packets.

In some embodiments, the baseband chip further includes an SDAP circuit configured to cause the PDCP circuit to organize the Layer 3 data packets based on QoS.

According to still another aspect of the present disclosure, a method for Layer 2 downlink data processing is disclosed. A first set of result statuses based on information related to Layer 1 transport blocks is received by an MCU. A first set of commands is provided by the MCU based on the first set of result statuses to control a MAC circuit to process MAC headers of the Layer 1 transport blocks. A second set of result statuses based on the processing result of the MAC circuit is received by the MCU. A second set of commands is provided by the MCU based on the second set of result statuses to control an RLC circuit to process RLC headers of the Layer 1 transport blocks. A third set of result statuses based on the processing result of the RLC circuit is received by the MCU. A third set of commands is provided by the MCU based on the third set of result statuses to control a PDCP circuit to process PDCP headers and payloads of the Layer 1 transport blocks, and generate Layer 3 data packets based on the processed PDCP headers and payloads of the Layer 1 transport blocks.

In some embodiments, to provide each set of the commands, the respective set of the commands are stored into a corresponding command queue in a memory. In some embodiments, to receive each set of the result statuses, the respective set of the result statuses are retrieved from a corresponding status queue in the memory.

The foregoing description of the specific embodiments will so reveal the general nature of the present disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The particular arrangements provided are illustrative and without limitation. Accordingly, the functional blocks, modules, and steps may be re-ordered or combined in different ways than in the examples provided above. Likewise, certain embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

What is claimed is:

1. A baseband chip, comprising:
a plurality of Layer 2 circuits configured to receive Layer 1 transport blocks and generate Layer 3 data packets from the Layer 1 transport blocks in an in-line manner; and
a microcontroller unit (MCU) operatively coupled to the Layer 2 circuits and configured to control, through a plurality sets of commands, at least one of the Layer 2 circuits to generate the Layer 3 data packets from the Layer 1 transport blocks.

2. The baseband chip of claim 1, wherein the Layer 2 circuits comprise:
an interface configured to receive the Layer 1 transport blocks based on a set of interface commands from the MCU; and
a buffer operatively coupled to the interface and configured to store the Layer 1 transport blocks.

3. The baseband chip of claim 2, wherein the buffer is further configured to buffer the Layer 1 transport blocks to be adapted to Layer 1 data rate.

4. The baseband chip of claim 2, wherein the Layer 2 circuits further comprise:
a Media Access Control (MAC) circuit operatively coupled to the buffer and configured to process MAC headers of the Layer 1 transport blocks received from the buffer based on a set of MAC commands from the MCU; and
a Radio Link Control (RLC) circuit operatively coupled to the MAC circuit and configured to process RLC headers of the Layer 1 transport blocks received from the MAC circuit based on a set of RLC commands from the MCU.

5. The baseband chip of claim 4, wherein none of the MAC circuit and the RLC circuit processes payloads of the Layer 1 transport blocks stored in the buffer.

6. The baseband chip of claim 4, wherein the Layer 2 circuits further comprise a Packet Data Convergence Protocol (PDCP) circuit operatively coupled to the RLC circuit and the buffer and configured to, based on a set of PDCP commands from the MCU:
process PDCP headers of the Layer 1 transport blocks received from the RLC circuit;
process payloads of the Layer 1 transport blocks received from the buffer; and
generate the Layer 3 data packets based on the processed PDCP headers and payloads of the Layer 1 transport blocks.

7. The baseband chip of claim 6, wherein the Layer 2 circuits further comprise a Service Data Adaptation Protocol (SDAP) circuit configured to cause the PDCP circuit to organize the Layer 3 data packets based on Quality of Service (QoS).

8. The baseband chip of claim 7, wherein each of the SDAP, PDCP, RLC, and MAC circuits is an application-specific integrated circuit (ASIC).

9. The baseband chip of claim 1, further comprising a memory operatively coupled to the MCU and the Layer 2 circuits and configured to store the plurality sets of commands into a plurality of command queues to be fetched by the at least one of the Layer 2 circuits, respectively.

10. The baseband chip of claim 9, wherein the memory is further configured to receive a plurality sets of result statuses from the at least one of the Layer 2 circuits, and store the plurality sets of result statuses into a plurality of status queues, respectively.

11. The baseband chip of claim 10, wherein the MCU is further configured to:
retrieve the plurality sets of result statuses from the memory; and
generate each set of the commands for controlling a respective one of the Layer 2 circuits based on a corresponding set of the result statuses, wherein the corresponding set of the result status are from another one of the Layer 2 circuits at a lower layer in Layer 2 protocol stack than the respective one of the Layer 2 circuits.

12. The baseband chip of claim 1, wherein the Layer 2 circuits are configured to pass the Layer 1 transport blocks through the Layer 2 circuits without storing the Layer 1 transport blocks in an external memory.

13. A baseband chip, comprising:
a buffer configured to store Layer 1 transport blocks;
a Medium Access Control (MAC) circuit configured to process MAC headers of the Layer 1 transport blocks received from the buffer;
a Radio Link Control (RLC) circuit configured to process RLC headers of the Layer 1 transport blocks received from the MAC circuit; and
a Packet Data Convergence Protocol (PDCP) circuit configured to:
process PDCP headers of the Layer 1 transport blocks received from the RLC circuit;
process payloads of the Layer 1 transport blocks received from the buffer; and
generate Layer 3 data packets based on the processed PDCP headers and payloads of the Layer 1 transport blocks.

14. The baseband chip of claim 13, wherein each of the PDCP, RLC, and MAC circuits is an application-specific integrated circuit (ASIC).

15. The baseband chip of claim 13, further comprising an interface configured to:
receive the Layer 1 transport blocks, and forward the Layer 1 transport blocks to the buffer; and
based on information related to the Layer 1 transport blocks and an interface lookup table (LUT) circuit, generate a set of MAC commands,
wherein the MAC circuit is configured to process the MAC headers based on the set of MAC commands.

16. The baseband chip of claim 13, wherein:
the MAC circuit is further configured to, based on the processed MAC headers and a MAC LUT circuit, generate a set of RLC commands; and
the RLC circuit is configured to process the RLC headers based on the set of RLC commands.

17. The baseband chip of claim 13, wherein:
the RLC circuit is further configured to, based on the processed RLC headers and a PDCP LUT circuit, generate a set of PDCP commands; and
the PDCP circuit is configured to, based on the set of PDCP commands, process the PDCP headers and the payloads and generate the Layer 3 data packets.

18. The baseband chip of claim 13, further comprising a Service Data Adaptation Protocol (SDAP) circuit configured to cause the PDCP circuit to organize the Layer 3 data packets based on Quality of Service (QoS).

19. A method for Layer 2 downlink data processing, comprising:
receiving, by a microcontroller unit (MCU), a first set of result statuses based on information related to Layer 1 transport blocks;
providing, by the MCU, a first set of commands based on the first set of result statuses to control a Medium Access Control (MAC) circuit to process MAC headers of the Layer 1 transport blocks;
receiving, by the MCU, a second set of result statuses based on the processing result of the MAC circuit;
providing, by the MCU, a second set of commands based on the second set of result statuses to control a Radio Link Control (RLC) circuit to process RLC headers of the Layer 1 transport blocks;
receiving, by the MCU, a third set of result statuses based on the processing result of the RLC circuit; and
providing, by the MCU, a third set of commands based on the third set of result statuses to control a Packet Data Convergence Protocol (PDCP) circuit to process PDCP headers and payloads of the Layer 1 transport blocks, and generate Layer 3 data packets based on the processed PDCP headers and payloads of the Layer 1 transport blocks.

20. The method of claim 19, wherein:
providing each set of the commands comprises storing the respective set of the commands into a corresponding command queue in a memory; and
receiving each set of the result statuses comprises retrieving the respective set of the result statuses from a corresponding status queue in the memory.
